(19) United States
(12) Patent Application Publication
(10) Pub. No.: US 2005/0037790 A1
(43) Pub. Date: Feb. 17, 2005

(54) Method and system for selecting a vocoder in a mobile communication system

(76) Inventor: Yong Chang, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/917,493

(22) Filed: Aug. 13, 2004

(30) Foreign Application Priority Data
Aug. 16, 2003 (KR) 2003-56729

(51) Int. Cl. H04Q 7/20

(52) U.S. Cl. 455/510

(57) ABSTRACT

A method and system are provided for selecting a vocoder for processing a voice signal upon generation of the voice signal in a mobile communication system including a media gateway and a base station controller, both of which use a packet-based transmission technique and have an independent vocoder, and a mobile switching center (MSC) emulator for controlling the media gateway. In the method and system, the base station controller transmits a vocoder selection-related information set based on a service option requested by a mobile station to the MSC emulator. The MSC emulator selects a vocoder to be used from a vocoder in the base station controller and a vocoder in the media gateway according to the received vocoder selection-related information and whether any vocoder resource is available in the media gateway.

### PRIORITY

This application claims the benefit under 35 U.S.C. § 119(a) to an application entitled “Method and System for Selecting Vocoder in a Mobile Communication System” filed in the Korean Intellectual Property Office on Aug. 16, 2003 and assigned Serial No. 2003-56729, the entire contents of which are incorporated herein by reference.

### BACKGROUND OF THE INVENTION

1. Field of the Invention

The present invention relates generally to a method and system for transmitting voice signals in a mobile communication system. In particular, the present invention relates to a method and system for selecting a vocoder for transmitting voice signals.

2. Description of the Related Art

As the number of mobile communication subscribers rapidly increases and mobile communication services are being provided in association with Internet services, research is being conducted on technology for enabling the subscribers to receive various types of data services such as Internet services and multimedia services through mobile communication terminals. A mobile communication system supporting Code Division Multiple Access (CDMA) 2000 1× will be described herein below with reference to the accompanying drawing.

FIG. 1 is a block diagram illustrating a conventional CDMA 2000 1× system. The CDMA 2000 1× system, as illustrated in FIG. 1, is divided into a mobile switching center (MSC) 30 for switching voice and data transmitted and received by a mobile station (MS) 10 to a corresponding destination in association with a base station (BS) 20, and a packet data service node (PDSN) 40 for interfacing with an external network. In addition, the CDMA 2000 1× system includes an interworking function (IWF) 50 for converting circuit data into packet data prior to concatenation upon receipt of a data transmission request from the mobile switching center 30, and a packet control function (PCF) 60 connected between the packet data service node 40 and the base station 20, for interfacing voice signals and data.

The base station 20 comprises base transceiver stations (BTSs) 22a and 22b, wirelessly connected to the mobile station 10 for transmission and reception of voice and packet data, and a base station controller (BSC) 21 for controlling the base transceiver stations 22a and 22b.

An A1 interface for signaling and A2/A5 interfaces for user traffic, which are circuit data-only interfaces, are established between the mobile switching center (MSC) 30 and the base station controller 21. An A8 interface for user traffic and an A9 interface for signaling are established between the base station controller 21 and the packet control function 60. An A10 interface for user traffic and an A11 interface for signaling are established between the packet control function 60 and the packet data service node 40.

The base station controller 21 includes a vocoder (or transcoder) 23. The vocoder 23 converts a wireless vocoder frame (an exemplary Enhanced Variable-Rate Codec (EVRC) frame, Selectable Mode Vocoder (SMV) frame and Qualcomm-Code Excited Linear Prediction Coding (Q-CELP) frame) transmitted by the mobile station 10 via a wireless section into a 64-Kbps Pulse Code Modulation (PCM) vocoder frame which is a conventional wired vocoder frame not a wireless vocoder frame in order to forward the vocoder frame to a wired concentrating network

Conventionally, however, because a Time Division Multiplexing (TDM) transmission line is used as a transmission line between the base station controller and the mobile switching center in the mobile communication system, frames generated by a wireless vocoder are inefficiently transmitted. That is, frames generated by a wireless vocoder which uses a band below 13 Kbps are generated by the vocoder in the base station controller, and are transmitted using the whole band of 64 Kbps, thereby causing a reduction in efficiency of the transmission line and an increase in cost due to the use of the TDM transmission line.

In addition, because the existing circuit-based system are inefficiently transmitted high-rate packet data for Internet services and multimedia services, a study is being conducted on a mobile communication system for a packet-based Internet Protocol (IP) network. In the conventional system, the base station controller converts voice signals using its transcoder for the high-speed packet data services, thereby causing a waste of bandwidth. Therefore, it is necessary to implement a new system.

Further, if the conventional mobile communication system includes a new mobile switching center having a vocoder, collision occurs between the vocoder in the mobile switching center and the vocoder in the base station controller. To prevent the collision, a method for selecting one of the newly added vocoders and the existing vocoder is required.

### SUMMARY OF THE INVENTION

It is, therefore, an object of the present invention to provide a mobile communication system having a separate packet network in addition to a circuit network, suitable for a packet-based IP network.

It is another object of the present invention to provide a mobile communication system in which a base station controller and a media gateway using a packet-based transmission technique have their own separate vocoders for converting voice signals into digital signals.

It is further another object of the present invention to provide a method for selecting vocoders separately included in a base station controller and a media gateway for transmission and reception of voice signals between the media gateway using a packet-based transmission technique and the base station controller.

It is yet another object of the present invention to provide a method for selecting vocoders separately included in a base station controller and a media gateway for transmission and reception of voice signals between the media gateway using a Time Division Multiplexing (TDM)-based transmission technique and the base station controller.

To achieve the above and other objects, there is provided a method for selecting a vocoder for processing a voice signal upon generation of the voice signal in a mobile communication system including a media gateway and a base station controller, both of which use a packet-based transmission technique and have an independent vocoder, and a mobile switching center (MSC) emulator for controlling the media gateway. In the method, the base station controller transmits a vocoder selection-related information set based on a service option requested by a mobile station to the MSC emulator. The MSC emulator selects one vocoder to be used from a vocoder in the base station controller and a vocoder in the media gateway according to the received vocoder selection-related information and according to whether any vocoder resource is available in the media gateway.

To achieve the above and other objects, there is provided a system for selecting a vocoder for processing a voice signal upon generation of the voice signal in a mobile communication system using a packet-based transmission technique. In the system, a base station controller including a first vocoder, transmits a vocoder selection-related information set based on a service option requested by a mobile station to a mobile switching center (MSC) emulator. A media gateway including a second vocoder, converts the voice signal into a wireless vocoder frame or wired vocoder frame. The MSC emulator selects the vocoder from the first vocoder and the second vocoder according to the received vocoder selection-related information and according to whether any vocoder resource is available in the media gateway.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a conventional Code Division Multiple Access (CDMA) 2000 1× system;

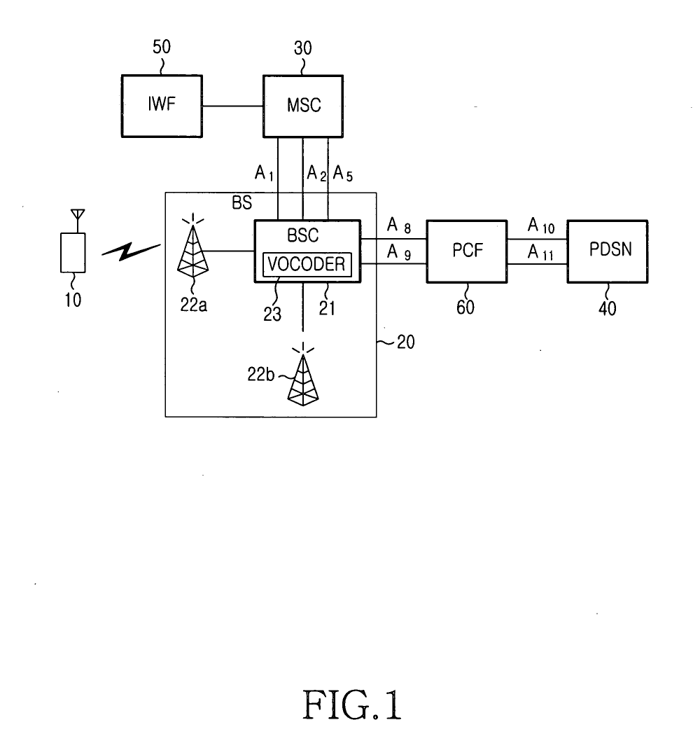

FIG. 2 is a block diagram illustrating a structure of a CDMA 2000 1× system according to an embodiment of the present invention;

FIG. 3 is a diagram illustrating an example of a protocol stack in a CDMA 2000 1× system according to an embodiment of the present invention;

FIG. 4 is a message flow diagram illustrating a call processing procedure for selecting a vocoder upon generation of voice signals according to an embodiment of the present invention;

FIG. 5 is a diagram illustrating a format of a Connection Management (CM) Service Request message according to an embodiment of the present invention;

FIG. 6 is a diagram illustrating a format of a Page Response message according to an embodiment of the present invention;

FIG. 7 is a diagram illustrating a format of an Additional Service Request message according to an embodiment of the present invention

FIG. 8 is a diagram illustrating a format of a Base Station Controller (BSC) Capability Information Elements (IE) according to an embodiment of the present invention;

FIG. 9A is a flowchart illustrating an operation of transmitting a CM Service Request message if there is available resources in a base station controller according to an embodiment of the present invention

FIG. 9B is a flowchart illustrating an operation of transmitting a CM Service Request message if there is no available resource in a base station controller according to an embodiment of the present invention; and

FIGS. 10A and 10B are flowcharts illustrating an operation of selecting a vocoder by an Mobile Switching Center (MSC) emulator according to an embodiment of the present invention.

Throughout the drawings, it should be noted that the same or similar elements are denoted by like reference numerals.

### DETAILED DESCRIPTION OF THE PREFERRED EMBODIMENT

A preferred embodiment of the present invention will now be described in detail with reference to the accompanying drawings. In the following description, a detailed description of known functions and configurations incorporated herein has been omitted for conciseness.

A mobile communication system according to an embodiment of the present invention is divided into an MSC emulator (MSCe) or a media gateway controller (MGC) for managing call control and mobility control by an existing mobile switching center (MSC), and a media gateway (MGW) including a vocoder for converting voice data from an analog signal to a digital signal prior to transmission. Therefore, interfaces for signaling and user information between a mobile switching center and a base station controller in the existing mobile communication system correspond to interfaces for signaling and user traffic between a media gateway and a base station controller in the mobile communication system according to an embodiment of the present invention.

In addition, in order to forward voice information to be transmitted and received to and from a mobile station, a frame protocol capable of determining a transmission state between the media gateway and the base station controller and an arrival order of packets is established.

The mobile communication system according to an embodiment of the present invention, which is a Code Division Multiple Access (CDMA) 2000 1× Legacy Mobile Station (MS) Domain (LMSD) system, is illustrated through a network reference model between a Radio Access Network (RAN) and a Core Network (CN). A structure of the mobile communication system (hereinafter referred to as a “CDMA 2000 1× system”) will now be described in detail herein below with reference to the accompanying drawing.

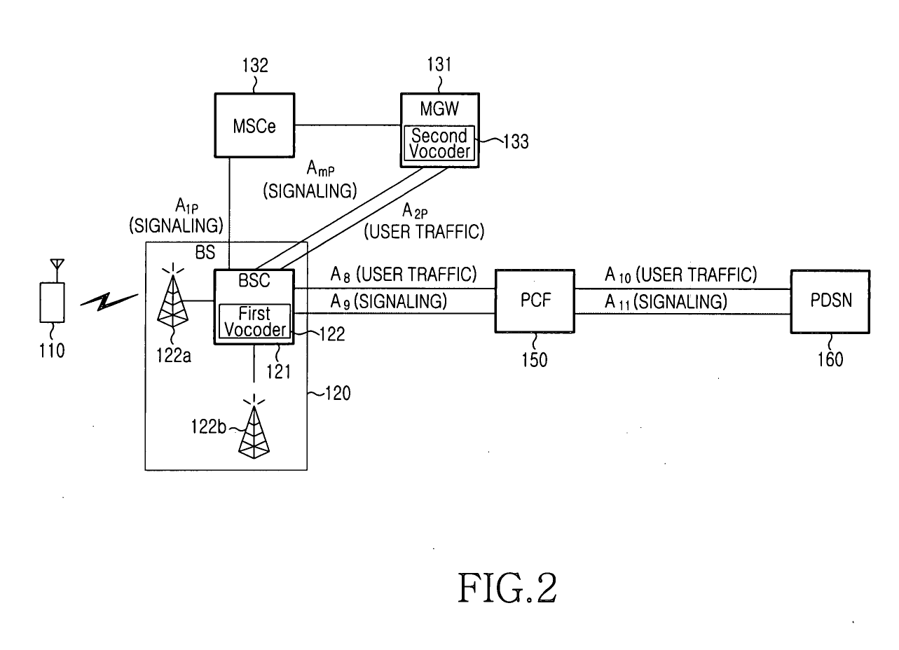

FIG. 2 is a block diagram illustrating a structure of a CDMA 2000 1× system according to an embodiment of the present invention. The CDMA 2000 1× system, as illustrated in FIG. 2, comprises a media gateway (MGW) 131 for switching voice and data transmitted and received by a mobile station (MS) 110 to a corresponding destination in association with a base station (BS) 120, and a packet data service node (PDSN) 160 for interfacing with an external network. In addition, the CDMA 2000 1× system includes an MSC emulator (MSCe) 132 or a media gateway controller (MSC) connected to the base station 120, for controlling the media gateway 131, and a packet control function (PCF) 150 connected between the packet data service node 160 and the base station 120, for interfacing voice and data. The base station 120 includes a plurality of base transceiver stations (BTSs) 122a and 122b, and a base station controller (BSC) 121 for controlling the base transceiver stations 122a and 122b.

The base station controller 121 includes a first vocoder 122 for converting analog voice signals into digital signals, and transmits and receives voice signals to and from the media gateway 131. The base station controller 121 may use a transcoder instead of the vocoder in order to convert the voice signals.

The media gateway 131 includes a second vocoder 133 for managing conversions between analog voice signals and digital signals. The media gateway 131 may also use a transcoder instead of the vocoder in order to convert the voice signals. In forward transmission, the second vocoder 133 converts a voce data frame transmitted from a conventional wired telephone into a wireless vocoder frame used by a mobile station using Pulse Code Modulation (PCM). In reverse transmission, the second vocoder 133 converts voice data generated by a wireless vocoder of the mobile station 110 into preferably 64-Kbps PCM voice data. A variable rate vocoder for controlling a data rate according to the rate of a user voice is used as the vocoder applied to the CDMA 2000 1× system. That is, the variable rate vocoder increases a data rate in performing a coding operation when the user speaks fast, and decreases a data rate in performing the coding operation when the user speaks slow or there is no user voice.

The MSC emulator 132 manages call control and mobility control, for example, exchanges signals for controlling the media gateway 131, and selects one of the first vocoder 122 and the second vocoder 133, to be used for transmission and reception of voice signals generated.

The packet control function 150 interworks with base station controller 121 via an A8 interface for user traffic and an A9 interface for signaling, and interworks with the packet data service node 160 via an A10 interface for user traffic and an A11 interface for signaling. The packet control function 150 performs handoff control and management, and manages a packet data service profile of the mobile station 110.

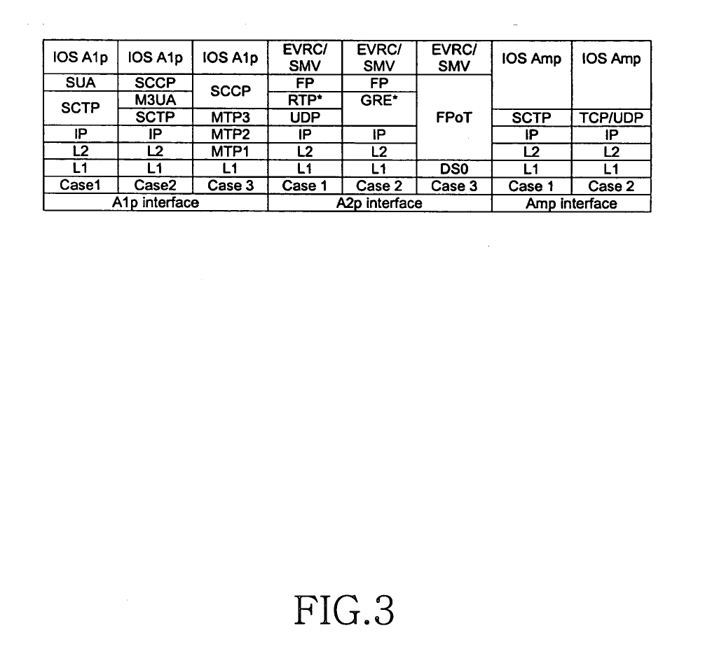

An interface between the MSC emulator 132 and the base station controller 121 is an A1p interface corresponding to the existing A1 interface, and an interface between the base station controller 121 and the media gateway 131 is an A2p interface corresponding to the existing A2 interface. An out-of-band signaling process for bearer setup and maintenance is performed through an Amp interface between the base station controller 121 and the media gateway 131. Here, functions defined in the Amp interface can also be performed in an A2p frame protocol through an in-of-band signaling process. The A1p, A2p and Amp interfaces are not circuit based, but packet e.g., Asynchronous Transfer Mode (ATM) or Internet Protocol (IP). An example of a protocol stack defined in the interface between the base station controller 121 and the media gateway 131 will now be described herein below with reference to FIG. 3.

As illustrated in FIG. 3, the protocol stack is divided into an A1p interface, an A2p interface, and an Amp interface, and each interface is divided according to Cases. Case 1 of the A1p interface is applied when a packet transport is used, Case 2 of the A1p interface is a different protocol available when a packet transport is used, and Case 3 of the A1p interface is the same protocol stack as the existing IOS A1 interface and is applied when a TDM transport is used. Further, Case 1 and Case 2 of the A2p interface are applied when a packet transport is used, and Case 1 is typically applied. Case 3 of the A2p interface is a protocol stack different from the existing IOS A2 interface, is applied when a TDM transport is used, and uses a new frame protocol FpoT defined in the TDM transport like in the packet transport. Case 1 and Case 2 of the Amp interface are applied when a signaling message is transmitted. When the transmission of a signaling message requires reliability, Case 1 is applied, and otherwise, Case 2 is applied.

Real time Transport Protocol (RTP) and Generic Route Encapsulation (GRE) formats used in a protocol stack of the A2p interface are slightly modified from conventional RTP and GRE formats in their functions, and it means that a function for multiplexing a plurality of users with one port and all functions of the existing RTP and GRE unnecessary for the A2p interface are not required.

The Amp interface is established for an out-of-band signaling process for bearer setup and maintenance between the base station controller 121 and the media gateway 131, and is formed as a separate interface. When the Amp interface interworks with the media gateway 131 via the MSC emulator 132, Session Control Transmission Protocol (SCTP) is used for a protocol stack. Such A1p, A2p and Amp interfaces are not circuit-based interfaces, but packet-based interfaces. In contrast, even when a transmission line between the base station controller 121 and the media gateway 131 is not a TDM transmission line, interfacing therebetween is performed via the A1p and A2p interfaces rather than the existing A1 and A2 interfaces.

An A2p frame protocol defined in the protocol stack will be described herein below. A frame protocol operating on RTP and GRE provides a procedure for processing a voice data frame and a control procedure during transmission and reception of voice information between the media gateway 131 and the base station controller 121, and the frame protocol includes the following major functions.

The A2p frame protocol used in the A2p interface performs the following five functions.

First, the frame protocol has a function of making a frame prior to transmission of voice data information, receiving a frame, separating control information and voice data information from the corresponding frame, and analyzing the separated control information and voice data information.

Second, the frame protocol has an initialization function including a function of designating a frame number transmitted and received when a Quality-of-Service (QoS) of a transmission line or a frame is transmitted and received prior to voice data forwarding between the base station controller 121 and the media gateway 131.

Third, the frame protocol has a function of setting up and maintaining synchronization during actual transmission and reception through a report on a delay in order to resolve the delay occurring during real-time transmission and reception of voice data.

Fourth, the frame protocol has a vocoder transmission control function for equally changing a vocoder in the media gateway 131 during a change in data rate or transmission mode of a vocoder used by a mobile station.

Fifth, the frame protocol has a function of adjusting a rate of voice data transmitted from the media gateway 131 at a particular time in order to multiplex a signaling message and secondary traffic generated by the base station controller 121 using a Dim-and-Burst technique and a Blank-and-Burst technique. A detailed description of the functions of the A2p frame protocol will be omitted herein.

A call processing procedure for selecting a vocoder to be used for generated voice signals using the structure and protocol stack described above will be described with reference to the accompanying drawing.

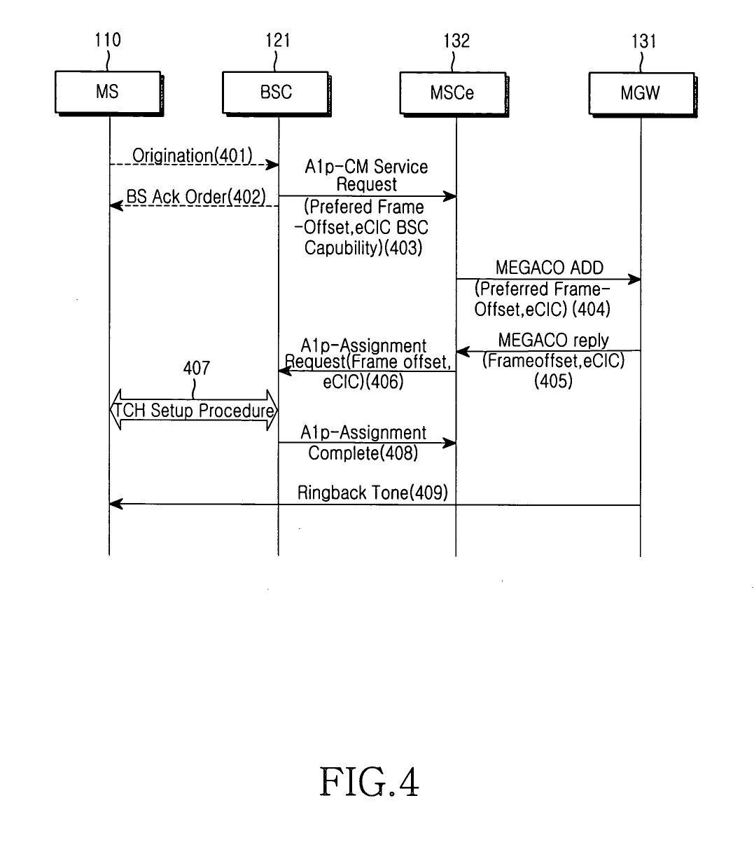

FIG. 4 is a message flow diagram illustrating a call processing procedure for selecting a vocoder upon generation of voice signals according to an embodiment of the present invention.

Referring to FIG. 4, in step 401, a mobile station (MS) 110 transmits an Origination message for originating an outgoing call to a base station controller (BSC) 121. In step 402, the base station controller 121 sends a BS Ack Order message to inform the mobile station 110 whether base station controller 121 has received the Origination message.

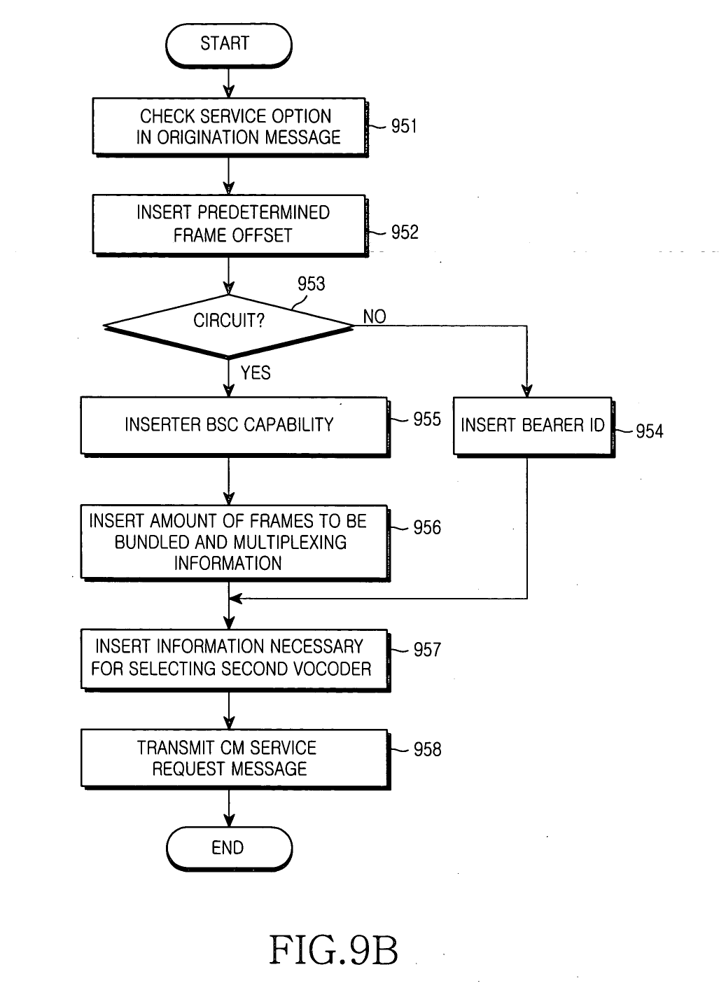

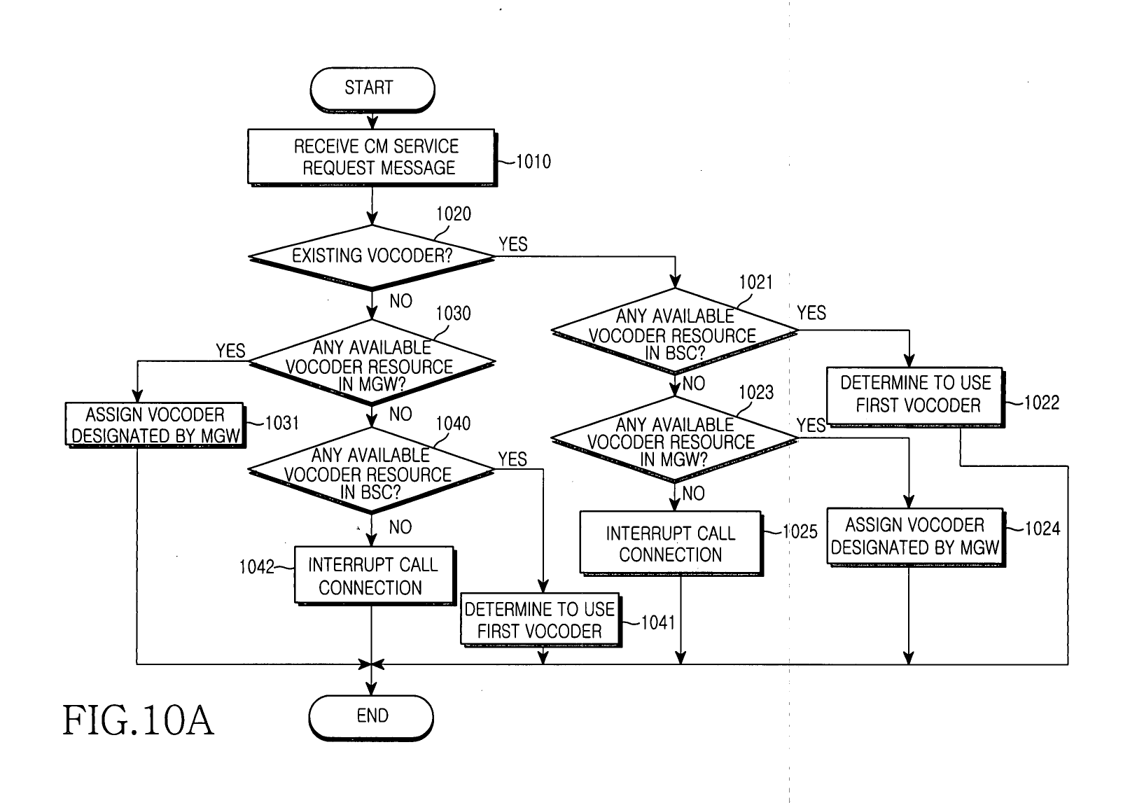

In step 403, the base station controller 121 transmits a Connection Management (CM) Service Request message including BSC capability information to an MSC emulator (MSCe) 132 via an A1p interface. At this point, the base station controller 121 determines which vocoder the mobile station 110 currently uses, through a service option in the Origination message sent by the mobile station 110. Thereafter, the base station controller 121 determines whether vocoder resource corresponding to the service option requested by the mobile station 110 is available or not in the base station controller 121. The base station controller 121 includes information corresponding to the determination result in the CM Service Request message, and transmits the CM Service Request message to the MSC emulator 132 so that the MSC emulator 132 can select a vocoder. That is, the base station controller 121 determines which vocoder the mobile station 110 uses, by analyzing a service option in the Origination message sent by the mobile station 110. Thereafter, the base station controller 121 determines whether vocoder resource corresponding to the service option requested by the mobile station 110 is available or not in the base station controller 121. For each case, the base station controller 121 determines whether a transport type between the base station controller 121 and the media gateway 131 represents circuit or packet, and inserts corresponding information in the CM Service Request message. Thereafter, the base station controller 121 sends the CM Service Request message to the MSC emulator 132. A detailed description of this operation will be made with reference to FIGS. 9A and 9B.

In step 404, the MSC emulator 132 receiving the CM Service Request message determines which vocoder it will use, according to whether vocoder resources sent by the base station controller 121 is available or not and transmission between the base station controller 121 and the media gateway 131 is based on packet or circuit. If the MSC emulator 132 uses a first vocoder 122 included in the base station controller 121, the MSC emulator 132 inserts corresponding information in a Media Gateway Control (MEGACO) Add message in the form of Session Description Protocol (SDP) information prior to transmission so that the media gateway 131 performs only transmission without using a second vocoder 133. However, if the MSC emulator 132 uses the second vocoder 133 included in the media gateway 131, the MSC emulator 132 requests the media gateway 131 to determine whether it can set up vocoder resource. Here, the MSC emulator 132 inserts a predetermined expanded circuit identity code (eCIC) received from the base station controller 121 into the MEGACO Add message before transmission.

In step 405, the media gateway 131 receiving the MEGACO Add message transmits a MEGACO Reply message as a response for availability of vocoder resource requested by the base station controller 121. In this case, if the transport type is circuit, the media gateway 131 determines whether it will bundle frame offset information finally determined and assigned in a vocoder, an eCIC number, and voice traffic of a corresponding user, or will multiplex the corresponding user with several other users. The media gateway 131 specifies the determination result in an eCIC value, inserts the eCIC into the MEGACO Reply message in the form of SDP information, and transmits the MEGACO Reply message to the MSC emulator 132. In order to transmit voice traffic to a reception side, the media gateway 131 performs a multiplexing operation of dividing voice traffic on a frame-by-frame basis and attaching a header to each of the divided voice traffics, and an operation of binding necessary information in the multiplexing operation is called “bundling.”

However, if the transport type is packet, the media gateway 131 assigns frame offset information finally determined and assigned in the second vocoder 133 and a bearer ID of the media gateway 131, inserts the assigned frame offset and bearer ID into the MEGACO Reply message in the form of SDP information, and transmits the MEGACO Reply message to the MSC emulator 132. Thereafter, the media gateway 131 prepares necessary vocoder resource.

However, if the MEGACO Add message received from the MSC emulator 132 has no vocoder-related information, the media gateway 131 omits the procedure if the transport type is a circuit or packet and provides only a transmission line, determining that the MSC emulator 132 uses only the first vocoder 122 in the base station controller 121.

In step 406, the MSC emulator 132 assigns the second vocoder 133 when the media gateway 131 has assigned the second vocoder 133. Otherwise, the MSC emulator 132 assigns the first vocoder 122 when the first vocoder 122 in the base station controller 121 is available. Thereafter, the MSC emulator 132 includes the eCIC value or bearer ID received from the media gateway 131 and a frame offset determined and assigned by the media gateway 131 in an A1p Assignment Request message, and transmits the A1p Assignment Request message to the base station controller 121.

In step 407, the base station controller 121 sets up a traffic channel (TCH) to the mobile station 110, In step 408, the base station controller 121 transmits an A1p Assignment Complete message indicating the completed setup of the traffic channel to the MSC emulator 132 in a response to the A1p Assignment Request message. The A1p Assignment Complete message includes a bearer ID for transmission of voice signals.

As the setup of a traffic channel is completed, the media gateway 131 transmits a ring back tone to the mobile station 110 in step 409.

Such a call procedure is used for selecting a vocoder applied when sending voice signals, and is applied in the same manner even when voice signals are received at a mobile station. In this case, however, BSC capability information inserted into the CM Service Request message is inserted into a Page Response message prior to being transmitted. A call processing procedure for the case where the voice signals are received is identical in operation to the call processing procedure for the case where the voice signals are transmitted, so a detailed description of the call processing procedure will be omitted.

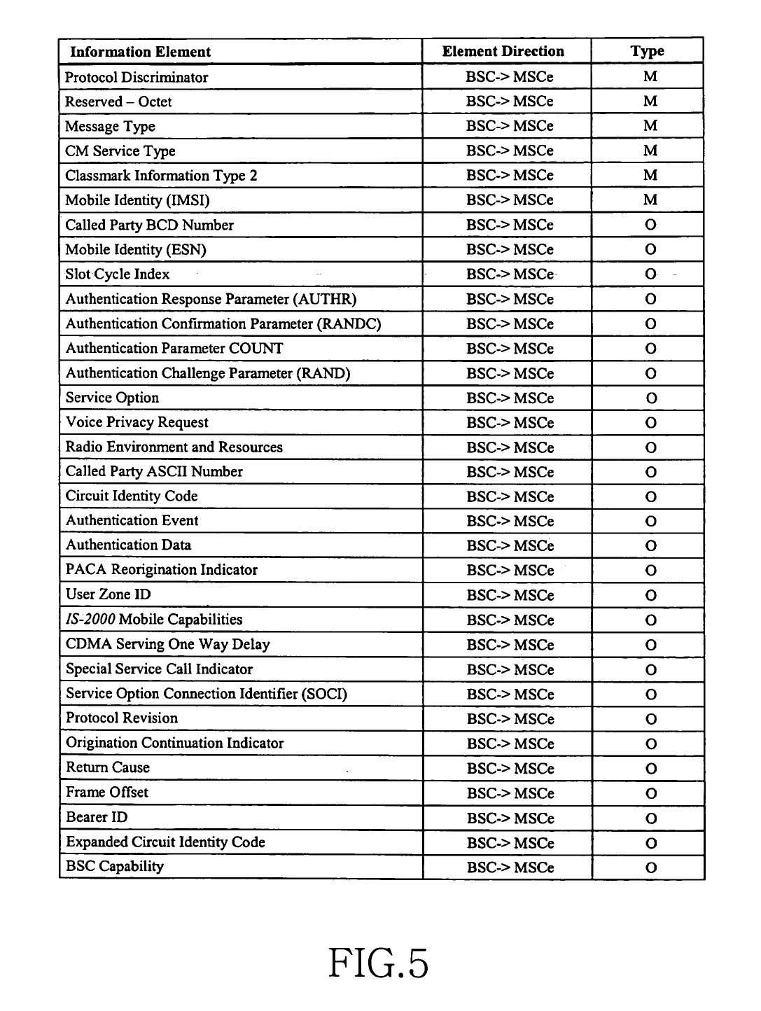

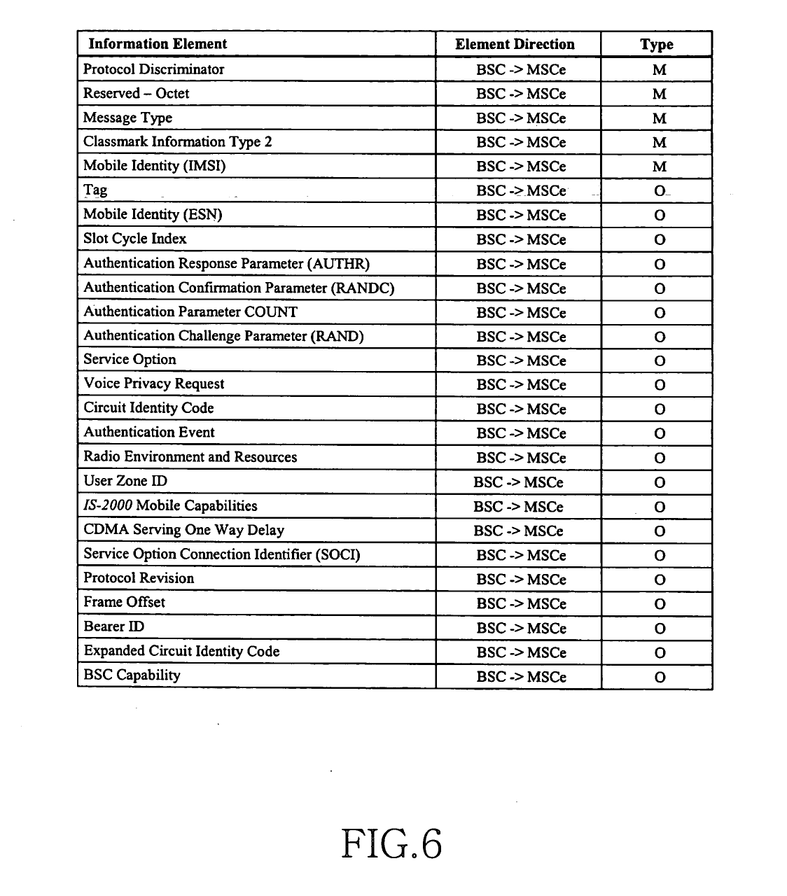

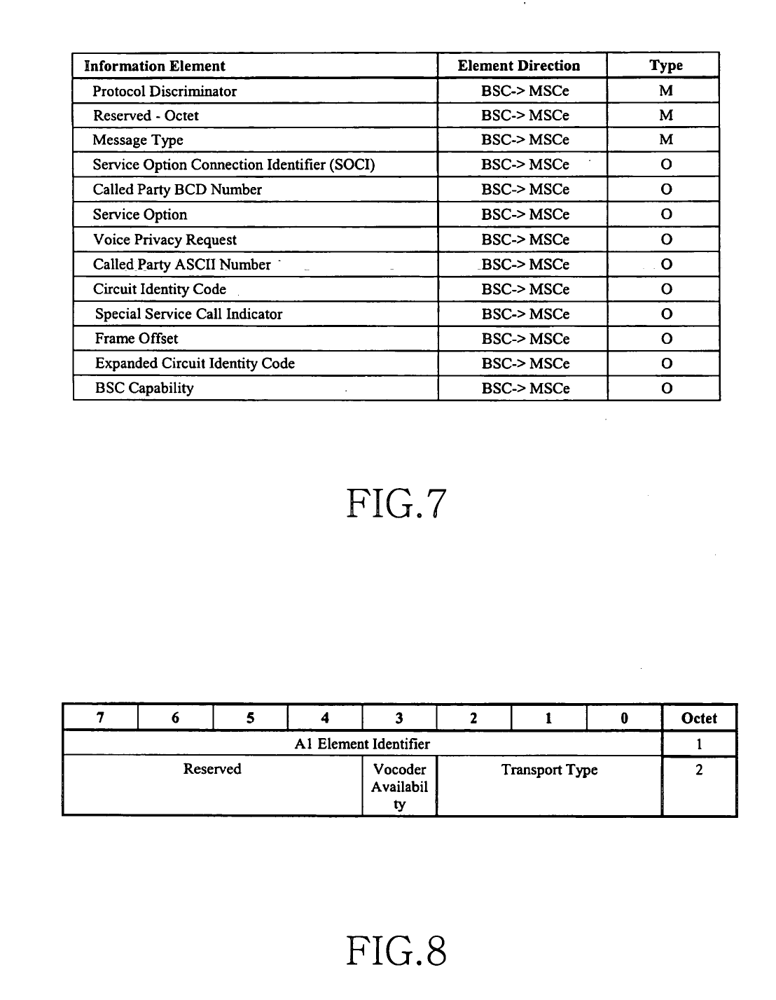

A format of the CM Service Request message is illustrated in FIG. 5, and a format of the Page Response message is illustrated in FIG. 6. In addition, a format of an Additional Service Request message used for Concurrent Service for transmitting voice signals during a packet service is illustrated in FIG. 7. The CM Service Request message, Page Response message, and Additional Service Request message are transmitted from the base station controller to the MSC emulator, and defined in 3GPP2, A.S0001-A, and IOSv4.3 which are incorporated by reference in their entirety. A detailed description of information elements (lEs) except a BSC Capability IE included in each message will be omitted herein.

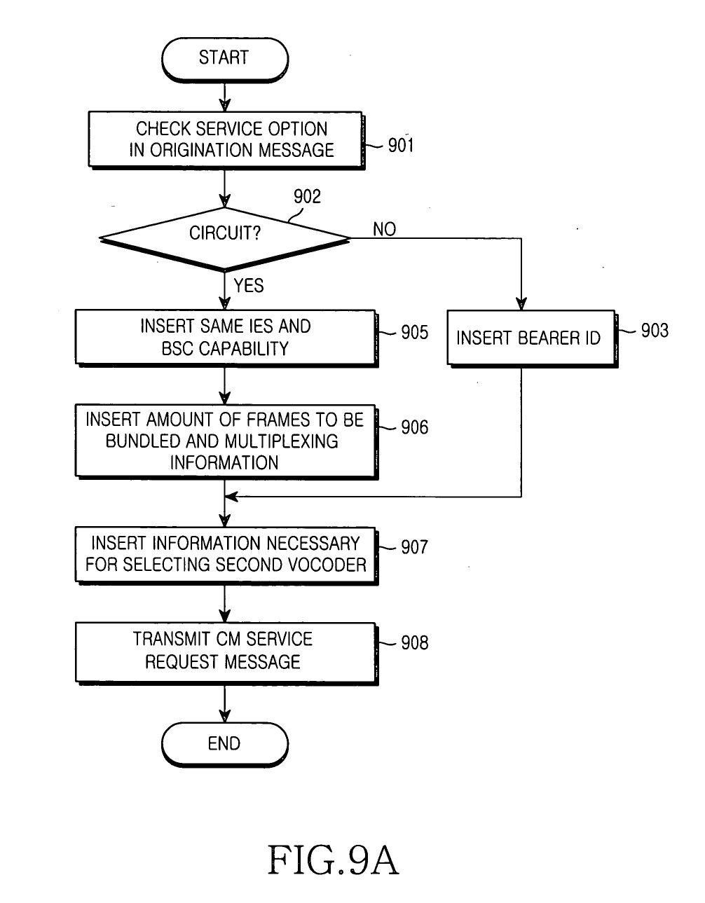

The BSC Capability IE is illustrated in FIG. 8, in which Octet 1 comprises an A1 Element Identifier field and Octet 2 is comprised of a Reserved field, a Vocoder Availability field, and a Transport Type field. The Vocoder Availability field indicates whether vocoder resource designated in Service Option by the mobile station is available in the base station controller. When the Vocoder Availability field is set to ‘1’ it indicates that the vocoder resource is available, and otherwise, it indicates that the vocoder resource is unavailable. The Transport Type field indicates a transport type used between the base station controller and the media gateway, and is set to ‘0’ for existing circuit and ‘1’ for packet.

With reference to FIGS. 9A and 9B, an operation of transmitting a CM Service Request message by a base station controller in the call processing procedure during generation of voice signals will be separately described herein below for the case where there is available resources in the base station controller and the case where there is no available resource in the base station controller.

FIG. 9A is a flowchart illustrating an operation of transmitting a CM Service Request message in the case where there is available resource in a base station controller according to an embodiment of the present invention.

Referring to FIG. 9A, in step 901, a base station controller 121 checks for a Service Option in an Origination message received from a mobile station 110. By checking for the Service Option, the base station controller 121 can determine whether the mobile station 110 uses an existing vocoder (Q-CELP and EVRC) or a new vocoder (SMV, GSM AMR, and Wideband Vocoder). It is assumed in FIG. 9A that vocoder resource used by the mobile station 110 is available in the base station controller 121.

In step 902, the base station controller 121 determines whether Transport Type is a circuit. If it is determined that Transport Type does not represent a circuit, the base station controller 121 inserts, in step 903, Bearer ID for transmitting voice traffic over a packet transport and BSC Capability information, instead of inserting circuit transport-related IEs such as CIC and eCIC into the existing CM Service Request message, and then proceeds to step 907.

However, if it is determined in step 902 that Transport Type is a circuit, the base station controller 121 inserts the same lEs as those used in the existing CM Service Request message and BSC Capability information, in step 905. Thereafter, in step 906, the base station controller 121 inserts information indicating whether to bundle user traffic and indicating the amount of frames to be simultaneously bundled, if bundling is needed, and information indicating whether to multiplex voice traffic of the user with voice traffic of several other users. Because the MSC emulator 132 can also select a second vocoder 133 in a media gateway 131, the base station controller 121 inserts, in step 907, a predetermined frame offset value and BSC Capability information, which are information necessary for selecting the second vocoder 133, into the CM Service Request message. Thereafter, in step 908, the base station controller 121 transmits the CM Service Request message including the information necessary for vocoder selection to the MSC emulator 132, and then ends the procedure.

However, when there is no available resource for a first vocoder 122 in the base station controller 121, the base station controller 121 is allowed to assign the second vocoder 133 in the media gateway 131.

FIG. 9B is a flowchart illustrating an operation of transmitting a CM Service Request message if there is no available resource in a base station controller according to an embodiment of the present invention.

Referring to FIG. 9B, in step 951, a base station controller 121 checks for a Service Option in an Origination message received from a mobile station 110. If there is not available resource for a first vocoder 122 as a result of the check, the base station controller 121 inserts, in step 952, a predetermined frame offset into a CM Service Request message in order to assign resources for a second vocoder 133.

In step 953, the base station controller 121 determines whether a Transport Type for a transport with a media gateway 131 is a circuit. If it is determined that Transport Type is not a circuit, the base station controller 121 inserts, in step 954, Bearer ID for transmitting voice traffic over a packet transport, instead of inserting circuit transport-related lEs such as CIC and eCIC into the existing CM Service Request message, and then proceeds to step 957.

However, if it is determined in step 953 that Transport Type is a circuit, the base station controller 121 inserts, in step 955, BSC Capability information indicating that the Transport Type is a circuit and a vocoder resource is unavailable, into a CM Service Request message. In step 956, the base station controller 121 inserts a preferred eCIC value into a CM Service Request message, and inserts information indicating whether to bundle user traffic, the amount of frames to be simultaneously bundled, if bundling is needed, and whether to multiplex voice traffic of the user with voice traffic of several other users. Because the MSC emulator 132 can also select a second vocoder 133 in a media gateway 131, the base station controller 121 inserts, in step 957, a predetermined frame offset value and BSC Capability information, which are information necessary for selecting the second vocoder 133, into the CM Service Request message, and then proceeds to step 958.

In step 958, the base station controller 121 transmits the CM Service Request message including the information necessary for vocoder selection to the MSC emulator 132, and then ends the procedure. An operation of selecting a vocoder by an MSC emulator that has received the CM Service Request message will be described herein below with reference to the accompanying drawings.

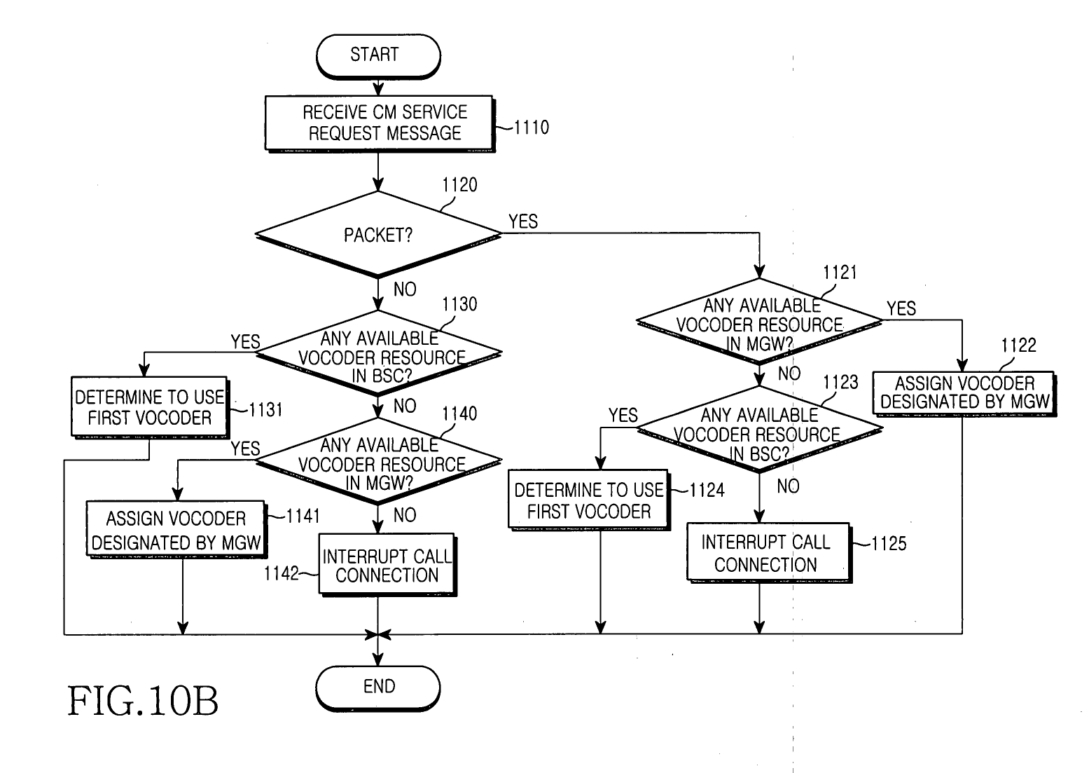

FIGS. 10A and 10B are flowcharts illustrating an operation of selecting a vocoder by an MSC emulator according to an embodiment of the present invention. FIG. 10A is a flowchart illustrating a selection operation based on a vocoder currently used by a mobile station, and FIG. 10B is a flowchart illustrating a selection operation based on a transport type checked through BSC Capability information in a CM Service Request message.

Referring to FIG. 10A, in step 1010, an MSC emulator 132 receives a CM Service Request message. In step 1020, the MSC emulator 132 checks Service Option in the CM Service Request message to determine whether a vocoder currently used by a mobile station 110 is an exiting vocoder (Q-CELP and EVRC) or a new vocoder (SMV, Wideband Vocoder, and GSM AMR). If it is determined that the vocoder currently used by the mobile station 110 is an existing vocoder, the MSC emulator 132 determines in step 1021 whether resources for a first vocoder 122 are available. If resources for a first vocoder 122 are available, the MSC emulator 132 determines whether to use the first vocoder 122 in step 1022, and then ends the procedure. However, if it is determined in step 1021 that resources for a first vocoder 122 are unavailable, the MSC emulator 132 determines in step 1023 whether there is any available vocoder resources in a media gateway 131 in order to use the resource for a second vocoder 133, while sending a frame offset included in the CM Service Request message. If it is determined that there is available vocoder resources in the media gateway 131, the MSC emulator 132 assigns a vocoder as finally designated by the media gateway 131 in step 1024, and then ends the procedure. Otherwise, the MSC emulator 132 interrupts the call connection in step 1025, and then ends the procedure.

However, if it is determined in step 1020 that the vocoder currently used by the mobile station 110 is a new vocoder, the MSC emulator 132 determines in step 1030 whether there is any available resource for the second vocoder 133 while sending a frame offset received from the base station controller 121 through the CM Service Request message. If it is determined that there is available vocoder resource in the media gateway 131, the MSC emulator 132 assigns a vocoder as finally designated by the media gateway 131 in step 1031, and then ends the procedure. However, if it is determined in step 1030 that there is no available vocoder resource in the media gateway 131, the MSC emulator 132 determines in step 1040 whether there is any available vocoder resource in the base station controller 121 by analyzing the CM Service Request message transmitted from the base station controller 121. If there is available vocoder resources in the base station controller 121, the MSC emulator 132 determines, in step 1041, to use the first vocoder 122, informs the base station controller 121 of the determination result, and then ends the procedure. Otherwise, the MSC emulator 132 interrupts the call connection in step 1042, and then ends the procedure.

Referring to FIG. 10B, in step 1110, an MSC emulator 132 determines a vocoder requested by a mobile station 110 by reading the Service Option in a CM Service Request message transmitted by a base station controller 121. In step 1120, the MSC emulator 132 determines whether the Transport Type is a packet or circuit. If it is determined that Transport Type is a packet, the MSC emulator 132 determines in step 1121 whether there are any available vocoder resources in the media gateway 131. If there are vocoder resources available in the media gateway 131, the MSC emulator 132 assigns a vocoder as finally designated by the media gateway 131 in step 1122, and then ends the procedure. However, if there is no available vocoder resource, the MSC emulator 132 determines in step 1123 whether there are any available vocoder resources in the base station controller 121. If there are available vocoder resources in the base station controller 121, the MSC emulator 132 uses the first vocoder 122 in step 1124, and then ends the procedure. However, if it is determined in step 1123 that there are no unavailable vocoder resources, the MSC emulator 132 interrupts the call connection in step 1125, determining that the call connection failed, and ending the procedure.

However, if it is determined in step 1120 that the Transport Type is a circuit, the MSC emulator 132 determines in step 1130 whether there are any available vocoder resources in the base station controller 121, by analyzing the CM Service Request message received from the base station controller 121. If there are available vocoder resources, the MSC emulator 132 uses the first vocoder 122 in step 1131, and ends the procedure. However, if it is determined in step 1130 that there are no unavailable vocoder resources, the MSC emulator 132 determines in step 1140 whether there are any available vocoder resources in the media gateway 131 while sending a frame offset transmitted from the base station controller 121. If there are available vocoder resources, the MSC emulator 132 assigns a vocoder as finally designated by the media gateway 131 in step 1141, and ends the procedure. Otherwise, the MSC emulator 132 interrupts the call connection in step 1142, and ends the procedure.

As can be appreciated from the foregoing description, the present invention selects only one vocoder from the plurality of vocoders located in a base station controller and a media gateway regardless of the type of transmission line between the base station controller and the media gateway, thereby preventing a waste of vocoder resource and contributing to efficient transmission and reception of voice signals.

While the invention has been shown and described with reference to a certain preferred embodiment thereof, it should be understood by those skilled in the art that various changes in form and details may be made therein without departing from the spirit and scope of the invention as defined by the appended claims.

1. A method for selecting a vocoder in a mobile communication system including a media gateway and a base station controller, both of which have an independent vocoder, and a mobile switching center (MSC) emulator for controlling the media gateway, the method comprising the steps of:
transmitting, by the base station controller, a vocoder selection-related information set based on a service option requested by a mobile station to the MSC emulator; and
selecting, by the MSC emulator, the vocoder to be used from a vocoder in the base station controller and a vocoder in the media gateway according to the received vocoder selection-related information and whether any vocoder resource is available in the media gateway.

2. The method of claim 1, wherein the step of transmitting the vocoder selection-related information to an MSC emulator comprises the steps of:
determining whether any vocoder resource is available in the base station controller, corresponding to the service option requested by the mobile station;
determining a transport type between the base station controller and the media gateway through the service option requested by the mobile station, if any vocoder resource is available in the base station controller; and
transmitting information indicating whether any vocoder resource is available in the base station controller and information necessary for selecting the vocoder in the media gateway to the MSC emulator, as the vocoder selection-related information, if the transport type is a circuit.

3. The method of claim 2, wherein the vocoder selection-related information transmitted to the MSC emulator is included in a connection management (CM) service request message, and the CM service request message includes information on the amount of frames to be bundled and whether to perform multiplexing.

4. The method of claim 2, wherein the information necessary for selecting the vocoder in the media gateway includes information on a predetermined frame offset, an expanded circuit identity code (eCIC) preferred by the base station controller, and vocoder resource availability for the base station controller, and is included in a CM service request message prior to being transmitted.

5. The method of claim 2, further comprising the step of:
transmitting a bearer identifier (ID) for transmitting the voice signal and information necessary for selecting the vocoder in the media gateway to the MSC emulator as the vocoder selection-related information, if the transport type is a packet.

6. The method of claim 2, further comprising the step of:
transmitting a predetermined frame offset for assigning the vocoder resource in the media gateway together with the vocoder selection-related information if no vocoder resources is available in the base station controller.

7. The method of claim 1, wherein the step of selecting a vocoder to be used comprises the steps of:
determining a vocoder used by the mobile station by analyzing the vocoder selection-related information received from the base station controller; and
selecting the vocoder to be used according to whether any vocoder resource is available in the base station controller if the vocoder currently used by the mobile station is an existing vocoder.

8. The method of claim 7, wherein the step of selecting the vocoder to be used according to whether any vocoder resource is available in the base station controller comprises the step of selecting the vocoder in the base station controller if any vocoder resource is available in the base station controller.

9. The method of claim 7, wherein the step of selecting the vocoder to be used according to whether any vocoder resource is available in the base station controller comprises the step of selecting a vocoder designated by the media gateway if no vocoder resource is available in the base station controller and vocoder resource is available in the media gateway.

10. The method of claim 7, further comprising the step of selecting the vocoder to be used according to whether any vocoder resource is available in the media gateway if the vocoder currently used by the mobile station is not an existing vocoder.

11. The method of claim 10, wherein the step of selecting the vocoder to be used according to whether any vocoder resource is available in the media gateway comprises the step of selecting a vocoder designated by the media gateway if any vocoder resource is available in the media gateway.

12. The method of claim 10, wherein the step of selecting the vocoder to be used according to whether any vocoder resource is available in the media gateway comprises the step of selecting the vocoder in the base station controller if no vocoder resource is available in the media gateway and vocoder resources are available in the base station controller.

13. The method of claim 1, wherein the step of selecting one vocoder to be used comprises the steps of:
determining a transport type between the base station control and the media gateway by analyzing the vocoder selection-related information received from the base station controller; and
selecting the vocoder to be used according to whether any vocoder resource is available in the media gateway if the transport type is packet.

14. The method of claim 13, wherein the step of selecting the vocoder to be used according to whether any vocoder resource is available in the media gateway comprises the step of selecting a vocoder designated by the media gateway if any vocoder resource is available in the media gateway.

15. The method of claim 13, wherein the step of selecting the vocoder to be used according to whether any vocoder resource is available in the media gateway comprises the step of selecting the vocoder in the base station controller if no vocoder resource is available in the media gateway and any vocoder resource is available in the base station controller.

16. The method of claim 13, further comprising the step of selecting the vocoder to be used according to whether any vocoder resource is available in the base station controller if the transport type is a circuit.

17. The method of claim 16, wherein the step of selecting the vocoder to be used according to whether any vocoder resource is available in the base station controller comprises the step of selecting the vocoder in the base station controller if any vocoder resource is available in the base station controller.

18. The method of claim 16, wherein the step of selecting the vocoder to be used according to whether any vocoder resource is available in the media gateway comprises the step of selecting a vocoder designated by the media gateway if any vocoder resource is available in the base station controller and any vocoder resource is available in the media gateway.

19. A method for selecting a vocoder by a mobile switching center (MSC) emulator in a mobile communication system including a base station controller and a media gateway, both of which include an independent vocoder, and an MSC emulator for controlling the media gateway, the method comprising the steps of;
receiving a vocoder selection-related information set based on a service option requested by a mobile station, from the base station controller; and
selecting one vocoder to be used from a vocoder in the base station controller and a vocoder in the media gateway according to the received vocoder selection-related information and whether any vocoder resource is available in the media gateway.

20. The method of claim 19, wherein the step of selecting a vocoder to be used comprises the steps of:
determining a vocoder used by the mobile station by analyzing the vocoder selection-related information received from the base station controller; and
selecting the vocoder to be used according to whether any vocoder resource is available in the base station controller if the vocoder currently used by the mobile station is an existing vocoder.

21. The method of claim 20, wherein the step of selecting the vocoder to be used according to whether any vocoder resource is available in the base station controller comprises the step of selecting the vocoder in the base station controller if any vocoder resource is available in the base station controller.

22. The method of claim 20, wherein the step of selecting the vocoder to be used according to whether any vocoder resource is available in the base station controller comprises the step of selecting a vocoder designated by the media gateway if no vocoder resource is available in the base station controller and any vocoder resource is available in the media gateway.

23. The method of claim 20, further comprising the step of selecting the vocoder to be used according to whether any vocoder resource is available in the media gateway if the vocoder currently used by the mobile station is not an existing vocoder.

24. The method of claim 23, wherein the step of selecting the vocoder to be used according to whether there is any vocoder resource is available in the media gateway comprises the step of selecting a vocoder designated by the media gateway if any vocoder resource is available in the media gateway.

25. The method of claim 23, wherein the step of selecting the vocoder to be used according to whether any vocoder resource is available in the media gateway comprises the step of selecting the vocoder in the base station controller if no vocoder resource is available in the media gateway and any vocoder resource is available in the base station controller.

26. The method of claim 19, wherein the step of selecting a vocoder to be used comprises the steps of:
determining a transport type between the base station control and the media gateway by analyzing the vocoder selection-related information received from the base station controller; and
selecting the vocoder to be used according to whether any vocoder resource is available in the media gateway if the transport type is a packet.

27. The method of claim 26, wherein the step of selecting the vocoder to be used according to whether any vocoder resource is available in the media gateway comprises the step of selecting a vocoder designated by the media gateway if any vocoder resource is available in the media gateway.

28. The method of claim 26, wherein the step of selecting the vocoder to be used according to whether any vocoder resource is available in the media gateway comprises the step of selecting the vocoder in the base station controller if no vocoder resource is available in the media gateway and any vocoder resource is available in the base station controller.

29. The method of claim 26, further comprising the step of selecting the vocoder to be used according to whether any vocoder resource is available in the base station controller if the transport type is a circuit.

30. The method of claim 29, wherein the step of selecting the vocoder to be used according to whether vocoder resource is available in the base station controller comprises the step of selecting the vocoder in the base station controller if any vocoder resource is available in the base station controller.

31. The method of claim 29, wherein the step of selecting the vocoder to be used according to whether any vocoder resource is available in the media gateway comprises the step of selecting a vocoder designated by the media gateway if any vocoder resource is available in the base station controller and vocoder resource is available in the media gateway.

32. A system for selecting a vocoder in a mobile communication system, the system comprising:
a base station controller including a first vocoder, for transmitting a vocoder selection-related information set based on a service option requested by a mobile station to a mobile switching center (MSC) emulator;
a media gateway including a second vocoder, for converting the voice signal into a wireless vocoder frame and a wired vocoder frame; and
the MSC emulator for selecting one vocoder from the first vocoder and the second vocoder according to the received vocoder selection-related information and according to whether any vocoder resource is available in the media gateway.

33. The system of claim 32, wherein the base station controller determines whether vocoder resource is available in the base station controller, corresponding to the service option requested by the mobile station,
determines a transport type between the base station controller and the media gateway through the service option requested by the mobile station, if any vocoder resource is available in the base station controller, and transmits information indicating whether any vocoder resource in the base station controller and information necessary for selecting the vocoder in the media gateway to the MSC emulator as the vocoder selection-related information, if the transport type is a circuit.

34. The system of claim 33, wherein the base station controller transmits a bearer identifier (ID) for transmitting the voice signal and information necessary for selecting the vocoder in the media gateway to the MSC emulator as the vocoder selection-related information, if the transport type is a packet.

35. The system of claim 33, wherein the base station controller transmits a predetermined frame offset for assigning vocoder resources in the media gateway together with the vocoder selection-related information if no vocoder resource is available in the base station controller.

36. The system of claim 32, wherein the MSC emulator determines a vocoder used by the mobile station by analyzing the vocoder selection-related information received from the base station controller, selects the vocoder to be used according to whether any vocoder resource is available in the base station controller if the vocoder currently used by the mobile station is an existing vocoder, and selects the vocoder to be used according to whether any vocoder resource is available in the media gateway if the vocoder currently used by the mobile station is not an existing vocoder.

37. The system of claim 32, wherein the MSC emulator determines a transport type between the base station control and the media gateway by analyzing the vocoder selection-related information received from the base station controller, selects the vocoder to be used according to whether any vocoder resource is available in the media gateway if the transport type is a packet, and selects the vocoder to be used according to whether any vocoder resource is available in the base station controller if the transport type is a circuit.
